(19) United States
(12) Patent Application Publication
(10) Pub. No.: US 2008/0256859 A1
(43) Pub. Date: Oct. 23, 2008

(54) Reformer Mixing Chamber and Method for the Operation Thereof

(76) Inventors: Ralf Peters, Wurselen (DE); Paul Cremer, Bedburg (DE); Joachim Pasel, Julich (DE); Zdenek Pors, Julich (DE); Detlef Stolten, Aachen (DE)

Correspondence Address: K.F. ROSS P.C., 5683 RIVERDALE AVENUE, SUITE 203 BOX 900, BRONX, NY, 10471-0900, US

(21) Appl. No.: 11/667,400

(22) PCT Filed: Nov. 12, 2005
(86) PCT No.: PCT/DE05/02043

§ 371 Date: Jun. 23, 2008

(30) Foreign Application Priority Data
Nov. 17, 2004 (DE) 10 2004 055 426.9

(51) Int. Cl. B01F 3/02; C01B 3/38

(52) U.S. Cl. 48/189.2; 48/197 FM

(57) ABSTRACT

The invention relates to a reformer mixing chamber comprising a water vapour-air mixture feeding line and a binary nozzle for supplying a fuel-air mixture, wherein said mixing chamber is rotationally symmetrically shaped and the flow direction of the binary nozzle and the water vapour-air mixture feeding line are axially and oppositely oriented. The inventive mixing chamber is advantageous in that it makes it possible to carry out the fuel as complete as possible conversion. For this purpose, the fuel-air mixture is supplied to the mixing chamber by means of a second binary nozzle, thereby making it possible to supply the mixing chamber with the water vapour-air mixture by another feeding line, wherein the fuel-air mixture flows in the direction opposite to the water vapour-air mixture.

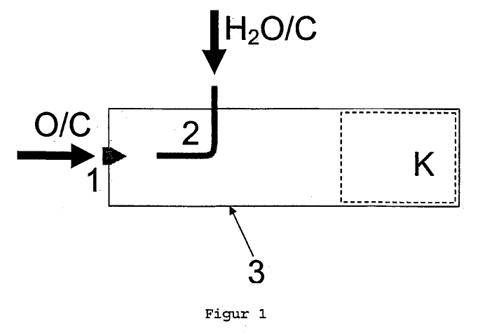

The invention relates to an effective mixing chamber for a reformer, in particular a reformer for producing middle distillates, and a method for operating the mixing chamber.

### PRIOR ART

Autothermic reforming represents a promising alternative to classical steam reforming for the production of hydrogen. In the process, an oxygen-water mixture is reacted with CₙHₘ hydrocarbon in a reactor without an external heat source, according to the following equations:

CₙHₘ+nH₂O→nCO+(m/2+n)H₂ΔH_{R}>0
(Steam Reforming)

CₙHₘ+n/2O₂→m/2H₂+nCOΔH_{R}<0
(Partial Oxidation)

For methane, CH₄ (n=1, m=4), the reaction equations are as follows:

CH₄+H₂O→CO+3H₂ΔH_{R}=+206 kJ/mol

CH₄+0.5O₂→CO+2H₂ΔH_{R}=−35 kJ/mol

Oxygen is generally provided by air. The heat necessary for the steam reforming is supplied by the partial oxidation of the hydrocarbon. The process may therefore be carried out in an autothermic operating mode. In principle, higher efficiency is achievable since system-related enthalpy losses are possible only through the hot product gas stream. Autothermic reforming appears very promising, in particular for the use of fuel cell systems as the vehicle drive, with gasoline or diesel as fuel. This may be accounted for by the high reaction temperature (approximately 800° C.) and good reaction kinetics.

In addition to the development of suitable catalysts for autothermic reforming of middle distillates, the operational capability of a reformer depends essentially-on whether optimized operating conditions can be established. Reforming of liquid fuels places high demands on preparation of the starting materials before they enter the reaction zone of the reactor, i.e. the reformer.

Poor quality of the starting material mixture consistently has a detrimental effect on the conversion of the fuel. To avoid soot formation and so-called “hot spots” in the reaction zone, it is particularly important that the O₂/C and H₂O/C ratios remain as constant as possible with no fluctuation.

The mixing chamber of a reformer therefore has the following functions:
Supplying the fuel.
Atomizing and evaporating the fuel,
Forming a mixture (homogenizing the fuel concentration in the air-vapor stream),
Homogenizing the flow distribution (flow rate profile)

In principle, two possibilities for supplying the fuel are known from the prior art: gaseous feed via an external evaporator and internal injection and atomization of the liquid fuel.

For pure substances such as methanol or isooctane, the fuel is frequently evaporated separately. For more complex fuel mixtures such as gasoline or diesel, there is an increased risk of formation and deposition of carbonaceous deposits on the hot surfaces of the evaporator. In these methods it is disadvantageous that an additional external heat source is required, and process control has consistently proven to be difficult on account of the thermal capacity of the evaporator.

Direct injection of the fuel is usually carried out using a single-component or multi-component nozzle. In a single-component nozzle the fuel is atomized under high pressure. Examples of suitable single-component nozzles are the continuous swirl pressure atomizing nozzle that is commonly used in smaller heater furnaces using heating oil, or the high-pressure injector that is used in current gasoline and diesel engines. Also mentioned is the Venturi tube that is used for the intake and atomization of a liquid.

When a multi-component nozzle is used, the fuel is generally atomized in combination with a gas stream. Such nozzles generate very fine droplets having a diameter of approximately 10 to 30 μm. Three-component nozzles are also known in which, in addition to the liquid fuel and air, superheated steam is pumped through the nozzle.

Complete evaporation of the atomized fuel requires considerable heat that is supplied, for example, by a hot gaseous starting product stream of air and/or steam. However, it is important to note that under certain conditions the gas stream temperature necessary for evaporation may exceed the ignition temperature of the fuel.

Alternatively, the necessary heat may be provided by partial combustion of the fuel, or by heating the mixing chamber using an external heater.

In all of the above-referenced methods, however, decomposition of the fuel can disadvantageously precipitate carbonaceous deposits in particular on the reforming catalyst in the form of soot, and thus result in increasingly diminished activity of the catalyst.

### OBJECT AND APPROACH OF THE INVENTION

The object of the invention is to provide a particularly effective mixing chamber for a reformer that allows a particularly uniform distribution of the starting materials and homogenization of the flow distribution, and that therefore may be operated in a particularly effective manner. A further object of the invention is to provide a mixing chamber that substantially prevents undesired soot formation, and converts the fuel to the greatest extent possible in the subsequent reformer.

The objects of the invention are achieved by a method for operating a mixing chamber having the totality of features according to the main claim, and by a mixing chamber for a reformer according to the dependent claims. Advantageous embodiments of the method and of the device are contained in the dependent claims.

### SUMMARY OF THE INVENTION

The invention is a mixing chamber in which a fuel and an oxidizing agent are mixed, and this mixture is subsequently supplied to a reformer catalyst. Such a mixing chamber could, for example, be part of an autothermic reformer (ATR).

The mixing chamber for a reformer according to the invention has a dual-component nozzle that is suitable for supplying fuel and air. The dual-component nozzle also has a feed line that is provided for supplying steam. The feed line for the steam is oriented with respect to the dual-component nozzle in such a way that the steam flowing therefrom during operation of the mixing chamber flows countercurrent to the fuel-air mixture exiting the dual-component nozzle. The gas and vapor streams that are produced thus flow substantially countercurrent to each other.

For effective flow within the mixing chamber the mixing chamber advantageously has a rotation-symmetrical design, for example a cylinder. The dual-component nozzle is centrally located at an end face of the mixing chamber so that the jet exiting the dual-component nozzle parallel to the axis thereof may be distributed uniformly in the mixing chamber.

The steam is supplied from a side to the mixing chamber, for example, the feed line itself having as little influence on the flow as possible. In an advantageous design, therefore, the feed line is radially guided inside the mixing chamber in the direction of the axis, and then is bent in the direction of the dual-component nozzle. The outlet of the steam feed line and the outlet of the dual-component nozzle should be aligned with one another, in particular at an angle of 180°±5°.

In a further embodiment, the mixing chamber is shaped as a cylinder that tapers in the direction of the dual-component nozzle and in the direction of the subsequent catalyst, i.e. in the direction of a pre-chamber for the catalyst. These tapered regions have the advantageous effect that interfering turbulence outside the actual mixing and evaporation zones may consistently be greatly reduced or prevented entirely. In particular, tapering around the dual-component nozzle has proven to be very effective.

The method for operating the mixing chamber according to the invention comprises the following steps: The fuel and a portion of the required air are supplied through the dual-component nozzle. During stationary operation of the mixing chamber the dual-component nozzle has a temperature in a range from approximately 80° C. to 140° C., in particular approximately 120° C. On entering the mixing chamber, the fuel and air starting materials fed through the dual-component nozzle generally have temperatures that are similar to the dual-component nozzle. These temperatures are too low for the fuel to completely evaporate. The fuel is therefore initially present in the mixing chamber in the form of fine droplets having an average droplet diameter ranging from 10 μm to 30 μm.

The fuel present in the droplets is evaporated by mixing the fuel with a steam stream that flows countercurrent and that is mixed with the remaining air stream. The steam-air stream is led through the second feed line into the mixing chamber. The steam generally has a temperature between 350° C. and 540° C., in particular between 380° C. and 430° C. At these temperatures, contact with the fuel droplets results in instantaneous evaporation of the fuel. At the same time, the fuel concentration in the starting material gas stream is advantageously homogenized. Homogenization of the flow rate profile in the direction of the monolithic catalyst may also be achieved by suitable geometry of the mixing chamber and of the adjacent catalyst.

The mixing chamber according to the invention is particularly usable for fuels having a boiling range between 180° C. and 250° C. and having a low content of aromatics and sulfur. These fuels may in particular be produced synthetically according to the Fisher droplet process or by fractional distillation of naphtha.

### SPECIFIC DESCRIPTION

The subject matter of the invention is explained in greater detail below with reference to a single FIGURE and illustrated embodiment, without thereby limiting the subject matter of the invention.

The FIGURE shows an embodiment of the mixing chamber 3 according to the invention together with an adjacent catalyst device K. A fuel-air mixture (C/O) mixture is supplied to the mixing chamber via a first dual-component nozzle 1. A second feed line 2 is positioned such that a steam air mixture (H₂O/O) supplied to the mixing chamber via the second feed line is oriented virtually in counterflow to the exiting fuel-air mixture.

The aim is to provide the starting materials for the reformer by means of exact metering, mixture formation, possible evaporation, and homogeneous flow distribution in the direction of the catalyst. This is achieved in the mixing chamber according to the invention. As an example, for an ATR having a power rating of 3 kWₑ₁, 3.6 kg/h air, 1.73 kg/h water, and 800 g/h fuel are introduced into the mixing chamber.

In a first embodiment of the invention the mixing chamber 3 has a hollow cylindrical geometry. The diameter is approximately 50.8 mm, and the length of the ceramic interior is approximately 75 mm. The dual-component nozzle 1 is positioned at an end face of the mixing chamber 3 such that the fuel exiting the dual-component nozzle is fed in a direction to the adjacent catalyst. The spray angle is 30% [30° ], depending on the air throughput, but in actual practice is between 3° and 90°. The average fuel droplet size is generally 15 μm. The steam-air mixture 2 is supplied via a 6 mm×1 mm or 8 mm×1 mm steam pipe mounted on the side of the cylinder, the feed line into the mixing chamber being oriented in such a way that the outlet of the feed line is aligned directly, i.e. at an angle of 180°±2°, toward the dual-component nozzle. The distance between the dual-component nozzle and the feed line for the steam-air mixture is approximately 16.5 mm. The portion of air introduced with the fuel is generally between 50 and 85%, and the remainder is introduced together with the steam.

In operation, the flow rate of the feed line for the fuel-air mixture is set at 160 to 250 m/s at the nozzle, and the flow rate for the steam/air mixture is set at approximately 60 to 90 m/s. The temperature of the dual-component nozzle is 80-140° C.

When the fuel in the form of droplets meets the steam, the fuel is instantaneously and completely evaporated. The fuel is supplied to the subsequent catalyst device at a flow rate of approximately 0.8 m/s to 1.2 m/s.

1. A method for operating a mixing chamber for a reformer in which fuel is evaporated, characterized in that
a fuel-air mixture is supplied to the mixing chamber via a dual-component nozzle,
a steam-air mixture is supplied to the mixing chamber via an additional feed line, and
the fuel-air mixture flows countercurrent to the steam-air mixture.

2. The method according to preceding claim 1 wherein the fuel-air mixture is heated by the dual-component nozzle to temperatures between 80° C. and 150° C.

3. The method according to claim 1 wherein the supplied steam-air mixture has a temperature between 350° C. and 540° C.

4. The method according to claim 1 wherein the fuel-air mixture is supplied to the mixing chamber in an axial direction via the dual-component nozzle.

5. The method according to claim 1 wherein the fuel-air mixture is used in a ratio of 0.41 to 0.47.

6. The method according to claim 1 wherein the steam-air mixture is used in a ratio of 1.7 to 1.9.

7. A mixing chamber for a reformer, having a feed line for a steam-air mixture and a dual-component nozzle for supplying a fuel-air mixture, wherein
a) the mixing chamber is rotation symmetrical,
b) the flow directions of the dual-component nozzle and of the feed line for the steam-air mixture are axially aligned, and
c) the flow directions of the dual-component nozzle and of the feed line for the steam-air mixture are oppositely directed.

8. The mixing chamber according to preceding claim 7, having a cylindrical shape.

9. The mixing chamber according to claim 7 wherein the mixing chamber taps in the region of the dual-component nozzle.

10. The mixing chamber according to claim 7 wherein the flow directions of the dual-component nozzle and of the feed line for the steam-air mixture are oriented at an angle of 180°±2° with respect to one another.

11. The mixing chamber according to claim 7 having a cylindrical shape wherein the dual-component nozzle for supplying a fuel-air mixture is situated atone end of the cylinder so that the flow direction of the dual-component nozzle corresponds to the axis of the cylinder.

12. The mixing chamber according to claim 7 wherein the feed line for the steam-air mixture passes virtually perpendicularly through the cylinder wall from the side, and inside the cylinder is oriented toward the dual-component nozzle.
